(19) United States
(12) Patent Application Publication
(10) Pub. No.: US 2012/0007282 A1
(43) Pub. Date: Jan. 12, 2012

(54) Method for producing composite articles

(75) Inventor: Chih-Lung Liu, Kaohsiung City (TW)

(73) Assignee: ADVANCED INTERNATIONAL MULTITECH CO., LTD., Kaohsiung City (TW)

(21) Appl. No.: 12/924,969

(22) Filed: Oct. 8, 2010

(30) Foreign Application Priority Data
Jul. 8, 2010 (TW) 099122503

(51) Int. Cl. B29C 51/24

(52) U.S. Cl. 264/320

(57) ABSTRACT

A method for producing composite articles includes: (a) advancing continuously a lower mold release sheet; (b) disposing prepreg articles in a spaced-apart manner on the lower mold release sheet; (c) advancing continuously an upper mold release sheet above the lower mold release sheet so that each of the prepreg articles is sandwiched between the lower and upper mold release sheets; and (d) thermoforming the prepreg articles that are sandwiched between the lower and upper mold release sheets.

### CROSS-REFERENCE TO RELATED APPLICATION

This application claims priority of Taiwanese application no. 099122503, filed on Jul. 8, 2010.

### BACKGROUND OF THE INVENTION

1. Field of the Invention

This invention relates to a method for producing composite articles, more particularly to a method for continuously producing composite articles using prepreg articles.

2. Description of the Related Art

Composite articles manufactured from prepreg materials made from resin-impregnated fibers, such as resin-impregnated carbon fabric sheets, have a relatively high strength, a relatively light weight, and relatively good acid/base resistance and weather resistance. Hence, such composite articles are commonly used in the fabrication of fishing rods, golf club heads, rackets, printed circuit boards, airplane components, etc.

A conventional method for making a composite article involves cutting and stacking the prepreg materials to form a prepreg article, followed by thermoforming the prepreg article in a mold of a thermoforming device so as to produce the composite article having an intended shape.

During the thermoforming step, some resin is likely to stick to inner surfaces of the mold after curing, and thus, the composite article tends to stick to the mold via the cured resin and is hard to be removed from the mold. Furthermore, an additional step for removing the cured resin from the mold is necessary.

At present, in order to solve the above problem, two mold release films are attached to upper and lower surfaces of the prepreg article before the thermoforming step. Accordingly, the composite article can be easily removed from the mold after the thermoforming step is finished, and the resin can be prevented from spilling over and sticking to the inner surfaces of the mold.

However, in the current method that involves using the mold release films, each prepreg article is required to be attached with two of the mold release films that have been cut to conform with the shape of the prepreg article, and the mold release films have to be removed after the thermoforming step. Such attaching, cutting and removing operations of the mold release films are time-consuming and disadvantageous to continuous manufacture of the composite articles. Hence, the production efficiency of the current method for making the composite article involving use of the mold release films is still poor and needs further improvement.

### SUMMARY OF THE INVENTION

Therefore, an object of the present invention is to provide a method for producing composite articles that can overcome the aforesaid drawbacks associated with the prior art.

Accordingly, a method for producing composite articles of this invention comprises:

(a) advancing continuously a lower mold release sheet;

(b) disposing prepreg articles in a spaced-apart manner on the lower mold release sheet;

(c) advancing continuously an upper mold release sheet above the lower mold release sheet so that each of the prepreg articles is sandwiched between the lower and upper mold release sheets; and

(d) thermoforming the prepreg articles that are sandwiched between the lower and upper mold release sheets.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic diagram for illustrating the first preferred embodiment of a method for producing composite articles according to the present invention;

FIG. 2 is a flow chart illustrating consecutive steps of the first preferred embodiment of the method for producing composite articles according to the present invention; and

FIG. 3 is a schematic diagram for illustrating the second preferred embodiment of the method for producing composite articles according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

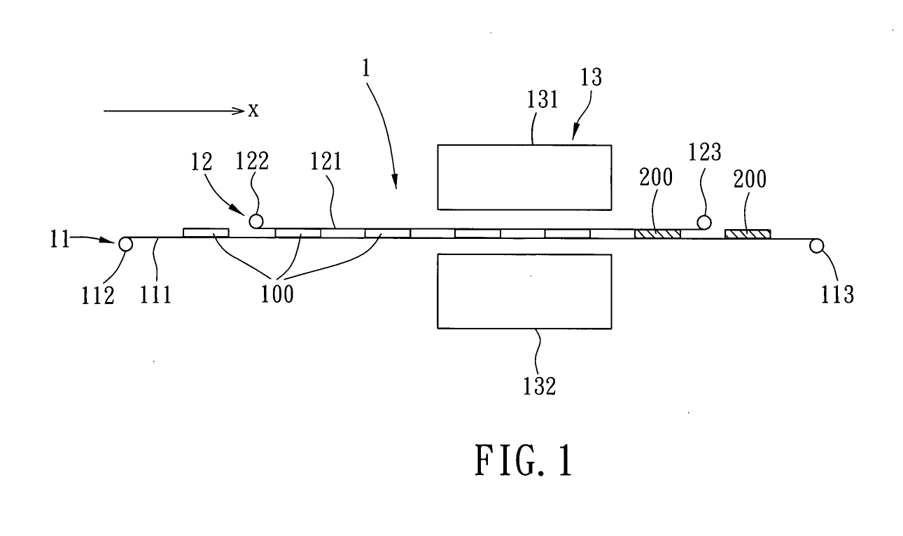

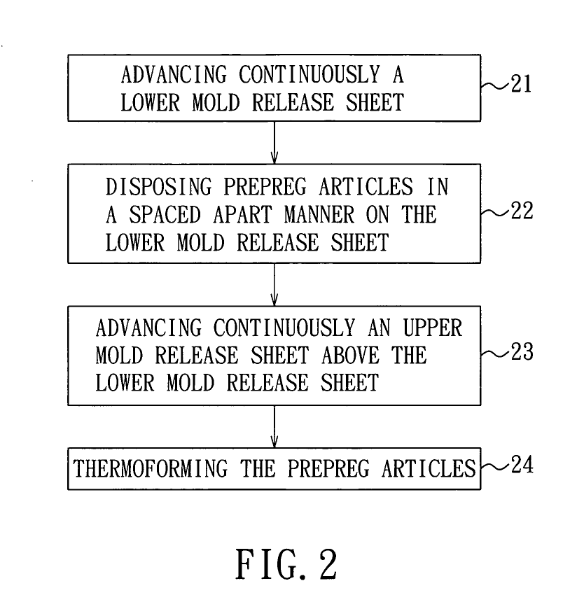

Referring to FIGS. 1 and 2, the first preferred embodiment of a method for producing composite articles according to the present invention involves using mold release sheets 111, 121 for conveying prepreg articles 100 so that thin type composite articles 200 are continuously formed by virtue of the steps described in the following paragraphs. Each of the prepreg articles 100 is constituted by prepreg materials.

At first, in step 21, a lower mold release sheet 111 is advanced continuously along a direction (X) using a lower advancing device 11 on a production line 1. The production line 1 includes the lower advancing device 11, an upper advancing device 12 and a thermoforming device 13.

The lower advancing device 11 includes a lower unwinding roller 112 that unwinds the lower mold release sheet 111, and a lower winding roller 113 that winds up the lower mold release sheet 111. Accordingly, the lower mold release sheet 111 is advanced between the lower unwinding roller 112 and the lower winding roller 113. Preferably, the lower mold release sheet 111 is passed through the thermoforming device 13 that is disposed downstream of the lower unwinding roller 112 and upstream of the lower winding roller 113.

In step 22, the prepreg articles 100 are disposed on the lower mold release sheet 111 in a spaced-apart manner and are conveyed by the lower mold release sheet 111 to move along the direction (X) to pass under the upper advancing device 12 and through the thermoforming device 13.

In step 23, an upper mold release sheet 121 is advanced above the lower mold release sheet 111 along the direction (X) using the upper advancing device 12.

The upper advancing device 12 includes an upper unwinding roller 122 and an upper winding roller 123. The upper unwinding roller 122 unwinds the upper mold release sheet 121 upstream of the thermoforming device 13. The upper winding roller 123 winds up the upper mold release sheet 121 downstream of the thermoforming device 13. Accordingly, the upper mold release sheet 121 is advanced between the upper unwinding roller 122 and the upper winding roller 123.

Preferably, the upper unwinding roller 122 is disposed downstream of the lower unwinding roller 112, and the upper winding roller 123 is disposed upstream of the lower winding roller 113. When each of the prepreg articles 100 passes between the upper unwinding and winding rollers 122, 123, it is sandwiched between the lower and upper mold release sheets 111, 121.

In step 24, each of the prepreg articles 100, which is sandwiched between the lower and upper mold release sheets 111, 121, is thermoformed in the thermoforming device 13 when passing therethrough.

Preferably, the thermoforming device 13 includes an upper mold unit 131 disposed above the lower and upper mold release sheets 111, 121, and a lower mold unit 132 disposed below the lower and upper mold release sheets 111, 121. The thermoforming device 13 may apply predetermined pressure and temperature to each of the prepreg articles 100 between the upper and lower mold units 131, 132 through the lower and upper mold release sheets 111, 121 such that resin included in each of the prepreg articles 100 is melted and formed, and is subsequently cured and cooled to produce the composite article 200. Then, the composite article 200 thus formed is advanced to move out of the thermoforming device 13.

By using the lower and upper mold release sheets 111, 121 that are respectively advanced using the lower advancing device 11 and the upper advancing device 12, the composite articles 200 are easily and automatically separated from the lower and upper mold release sheets 111, 121 after the step 24.

According to the method of this invention, on the production line 1, the prepreg articles 100 are disposed in a spaced-apart manner on the continuously advanced lower mold release sheet 111, and then, are sandwiched between the continuously advanced lower and upper mold release sheets 111, 121, followed by being thermoformed together with the continuously advanced lower and upper mold release sheets 111, 121, and finally being separated from the lower and upper mold release sheets 111, 121 to form the composite articles 200. Therefore, cutting operation of the mold release films as required in the conventional method is unnecessary. Besides, in the method of this invention, the prepreg articles 100 are removed from the thermoforming device 13 together with the continuously advanced lower and upper mold release sheets 111, 121 and then can be easily separated from the lower and upper mold release sheets 111, 121. Hence, compared with the conventional method, in the method of this invention, removal of the lower and upper mold release sheets 111, 121 from either the mold or the composite articles 200 can be conducted in a simplified and efficient way. In other words, the production efficiency of the method for making the composite articles 200 is greatly enhanced.

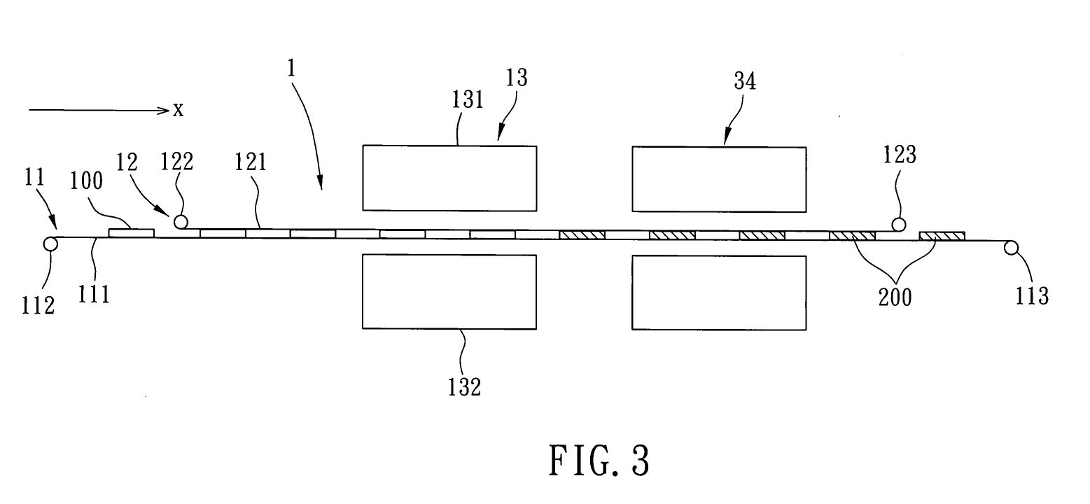

FIG. 3 illustrates the second preferred embodiment of the method for producing composite articles according to the present invention. The second preferred embodiment differ from the first preferred embodiment only in that the production line 1 further includes a cooling device 34 and that the method further comprises a step of cooling the prepreg articles 100 that have been thermoformed by passing the same through the cooling device 34. Preferably, the cooling device 34 is disposed downstream of the thermoforming device 13 and upstream of the lower winding roller 113.

In the second preferred embodiment, by virtue of the cooling device 34, the time required for cooling the resin included in each of the thermoformed prepreg articles 100 may be shortened so that the production efficiency of the method for making the composite articles 200 is further enhanced.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for producing composite articles, comprising:
(a) advancing continuously a lower mold release sheet;
(b) disposing prepreg articles in a spaced-apart manner on the lower mold release sheet;
(c) advancing continuously an upper mold release sheet above the lower mold release sheet so that each of the prepreg articles is sandwiched between the lower and upper mold release sheets; and
(d) thermoforming the prepreg articles that are sandwiched between the lower and upper mold release sheets.

2. The method of claim 1, wherein the lower mold release sheet is advanced between a lower unwinding roller that unwinds the lower mold release sheet and a lower winding roller that winds up the lower mold release sheet, and is passed through a thermoforming device that is disposed downstream of the lower unwinding roller and upstream of the lower winding roller.

3. The method of claim 2, wherein the upper mold release sheet is advanced between an upper unwinding roller that unwinds the upper mold release sheet upstream of the thermoforming device, and an upper winding roller that winds up the upper mold release sheet downstream of the thermoforming device.

4. The method of claim 3, wherein the upper unwinding roller is disposed downstream of the lower unwinding roller, and the upper winding roller is disposed upstream of the lower winding roller.

5. The method of claim 4, wherein the thermoforming device includes an upper mold unit disposed above the upper and lower mold release sheets, and a lower mold unit disposed below the upper and lower mold release sheets.

6. The method of claim 2, further comprising:
(f) cooling the prepreg articles that have been thermoformed by passing the same through a cooling device that is disposed downstream of the thermoforming device and upstream of the lower winding roller.
